(19) United States
(12) Patent Application Publication
(10) Pub. No.: US 2016/0085736 A1
(43) Pub. Date: Mar. 24, 2016

(54) DOCUMENT BROWSING DEVICE AND METHOD OF CONTROLLING DOCUMENT BROWSING DEVICE

(71) Applicant: KYOCERA Document Solutions Inc., Osaka (JP)

(72) Inventor: Seiji Miyagawa, Osaka (JP)

(21) Appl. No.: 14/856,381

(22) Filed: Sep. 16, 2015

(30) Foreign Application Priority Data
Sep. 22, 2014 (JP) 2014-192928

(51) Int. Cl. G06F 17/24; G06F 3/00; G06F 3/0483; G06F 3/01

(52) U.S. Cl. CPC G06F 17/241; G06F 3/017; G06F 3/005; G06F 3/0483

(57) ABSTRACT

A document browsing device causes a display portion to display a row specifying image which specifies one row in a page image, and detects a change in a gazing direction of a viewer. Further, when the gazing direction has shown a predetermined change along a row direction of character strings in the page image, the document browsing device updates a display state of the row specifying image on the display portion to a state to specify a row next to a row to be specified at a point of time of the satisfaction.

### INCORPORATION BY REFERENCE

This application is based upon and claims the benefit of priority from the corresponding Japanese Patent Application No. 2014-192928 filed on Sep. 22, 2014, the entire contents of which are incorporated herein by reference.

### BACKGROUND

The present disclosure relates to a document browsing device and a method of controlling the document browsing device.

Generally, a document browsing device which causes a display portion to display information of an electronic document such as an electronic book is known. The document browsing device includes the display portion and a control portion. The control portion causes the display portion to display a page image including a plurality of rows of character strings in a document.

Further, it is known that the document browsing device sometimes includes a camera which captures an image of a viewer and a detecting portion which detects a gazing direction of the viewer from the image captured by the camera.

By the way, the viewer who uses the document browsing device, after finishing reading a given row in the page image, tries to move his/her gaze to a head of a next row. In this case, the viewer may move the gaze to a head of an unintended row. The unintended row is, for example, a row that the viewer has already finished reading, or a row that is two or more rows ahead.

If the document browsing device is provided with a browsing portion guiding function of appropriately guiding the gaze of the viewer to a portion of the display document that the viewer wants to read, the document browsing device becomes more convenient.

Further, the document browsing device is often used in a state where the viewer grips, by one hand, a luggage such as a bag or a strap in a train. Hence, it is desired that the browsing portion guiding function is available even under a situation that the viewer uses the document browsing device only by one hand.

An object of the present disclosure is to provide a document browsing device which is able to appropriately guide a gaze of a viewer to a portion of a display document that the viewer wants to read, and a method of controlling the document browsing device.

### SUMMARY

A document browsing device according to one aspect of the present disclosure includes a first display control portion, a second display control portion, a gaze detecting portion and a condition determining portion. The first display control portion is configured to cause a display portion to display a page image including a plurality of rows of character strings in a document. The second display control portion is configured to cause the display portion to display a row specifying image which specifies one row in the page image. The gaze detecting portion is configured to detect a change in a gazing direction of a viewer who looks at the display portion. The condition determining portion is configured to refer to a detection result of the gaze detecting portion and determine whether or not a predetermined condition has been satisfied. The predetermined condition is a condition which indicates that the gazing direction has shown a predetermined change along a row direction of the character strings in the page image. Further, in the case where the predetermined condition has been satisfied, the second display control portion updates a display state of the row specifying image on the display portion, to a state to specify a row next to a row to be specified at a point of time of the satisfaction.

In a method of controlling a document browsing device according to another aspect of the present disclosure, the document browsing device includes a display portion and a gaze detecting portion configured to detect a change in a gazing direction of a viewer who looks at the display portion. The control method includes causing the display portion to display a page image including a plurality of rows of character strings in document. The control method further includes causing the display portion to display a row specifying image which specifies one row in the page image. The control method further includes referring to a detection result of the gaze detecting portion and determining whether or not a predetermined condition has been satisfied. The predetermined condition is a condition which indicates that the gazing direction has shown a predetermined change along a row direction of the character strings in the page image. The control method further includes, in the case where the predetermined condition has been satisfied, updating a display state of the row specifying image on the display portion, to a state to specify a row next to a row to be specified at a point of time of the satisfaction.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram showing a configuration of a document browsing device according to an embodiment of the present disclosure.

FIG. 2 is a flowchart showing an example of a process of browsing portion guiding control executed by the document browsing device according to the embodiment of the present disclosure.

FIG. 3 is a schematic view showing a first display state of a page image and a row specifying image of a document in the document browsing device according to the embodiment of the present disclosure.

FIG. 4 is a schematic view showing a second display state of a page image and a row specifying image of a document in the document browsing device according to the embodiment of the present disclosure.

FIG. 5 is a schematic view showing a third display state of a page image and a row specifying image of a document in the document browsing device according to the embodiment of the present disclosure.

FIG. 6 is a schematic view showing a fourth display state of a page image and a row specifying image of a document in the document browsing device according to the embodiment of the present disclosure.

### DETAILED DESCRIPTION

Hereinafter, an embodiment of the present disclosure will be described with reference to the accompanying drawings in order to allow understanding of the present disclosure. It should be noted that the following embodiment is an example embodying the present disclosure, and, by nature, does not limit the technical scope of the present disclosure.

[Schematic Configuration of Document Browsing Device]

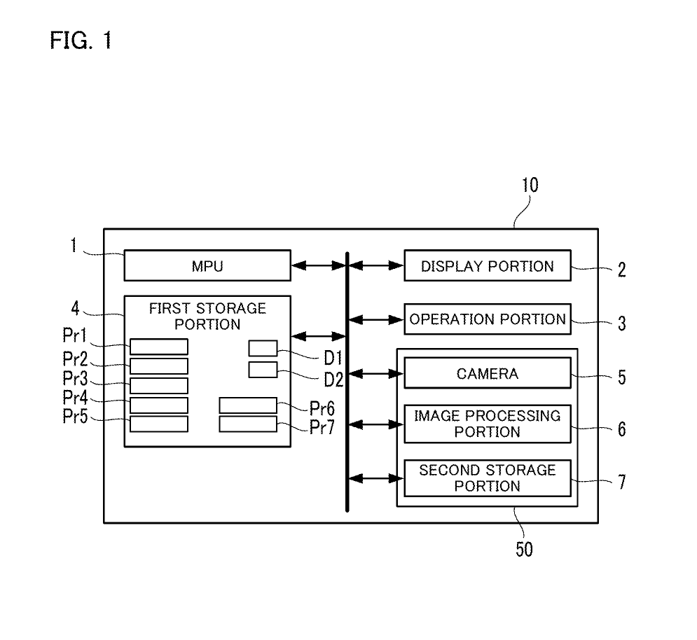

First, a configuration of a document browsing device 10 according to the embodiment of the present disclosure will be described with reference to FIG. 1. The document browsing device 10 is a device which causes a display portion to display information of an electronic document such as an electronic book.

For example, it is conceivable that the document browsing device 10 is an electronic book reader which is mainly used to browse the electronic book. Further, it is also conceivable that the document browsing device 10 is a general-purpose information processing device such as a smartphone or a tablet terminal which executes application software for document browsing.

As shown in FIG. 1, the document browsing device 10 includes an MPU (Micro Processor Unit) 1, a display portion 2, an operation portion 3, a first storage portion 4, a camera 5, an image processing portion 6 and a second storage portion 7, and the like.

The MPU 1 is a processor which executes various types of calculation processing. The first storage portion 4 is a non-volatile storage portion which stores programs that cause the MPU 1 to execute various types of processing, and stores various types of information that the MPU 1 refers to. Further, the first storage portion 4 is also a non-transitory computer-readable information storage medium in which the MPU 1 can record various types of information. For example, in the first storage portion 4, document data D1 which is data of an electronic document such as an electronic book is recorded in advance.

The display portion 2 is a device which displays an image of the electronic document based on the document data D1 and other images. For example, the display portion 2 is a panel display such as a liquid display panel or an organic electroluminescence display.

The display portion 2 is controlled by the MPU 1 to display a page image including a plurality of rows of character strings in the electronic document. That is, the MPU 1 reads the document data D1 from the first storage portion 4, and executes control of causing the display portion 2 to display the page image corresponding to contents of the document data D1. The MPU 1 which executes this control is an example of a first display control portion.

The operation portion 3 is an input interface of the MPU 1 which receives an operation of a viewer who is a user of the document browsing device 10 and thereby receives an input of information corresponding to the operation. For example, the operation portion 3 includes a touch panel formed on a surface of the display portion 2. When a display region of an operation icon on the touch panel is operated in a state where the operation icon is displayed on the display portion 2, information corresponding to the operation icon is inputted to the MPU 1.

The camera 5 is able to capture an image of a front of the display portion 2 of the document browsing device 10. Hence, the camera 5 can capture an image including the face of the viewer who looks at the display portion 2.

The image processing portion 6 is an element which receives an input of the image captured by the camera 5, and performs image processing calculation with respect to the input image. For example, the image processing portion 6 may be realized by a DSP (Digital Signal Processor) or an ASIC (Application Specific Integrated Circuit).

The second storage portion 7 is a high-speed-accessible storage portion which temporarily stores data of an image captured by the camera 5. The image processing portion 6 executes the image processing while accessing the second storage portion 7.

By the way, the viewer who uses the document browsing device 10, after finishing reading a given row in the page image, tries to move his/her gaze to a head of a next row. At this time, the viewer may move the gaze to a head of an unintended row. The untended row is, for example a row that the viewer has already finished reading, or a row that is two or more rows ahead.

If the document browsing device 10 is provided with a browsing portion guiding function of appropriately guiding the gaze of the viewer to a portion of the display document that the viewer wants to read, the document browsing device 10 becomes more convenient.

Further, the document browsing device 10 is often used in a state where the viewer grips, by one hand, a luggage such as a bag or a strap in a train. Hence, it is desired that the browsing portion guiding function is available even under a situation that the viewer uses the document browsing device 10 only by one hand.

MPU 1 and the image processing portion 6 execute processing described below, so that the document browsing device 10 according to the present embodiment can appropriately guide the gaze of the viewer to a portion of the display document that the viewer wants to read.

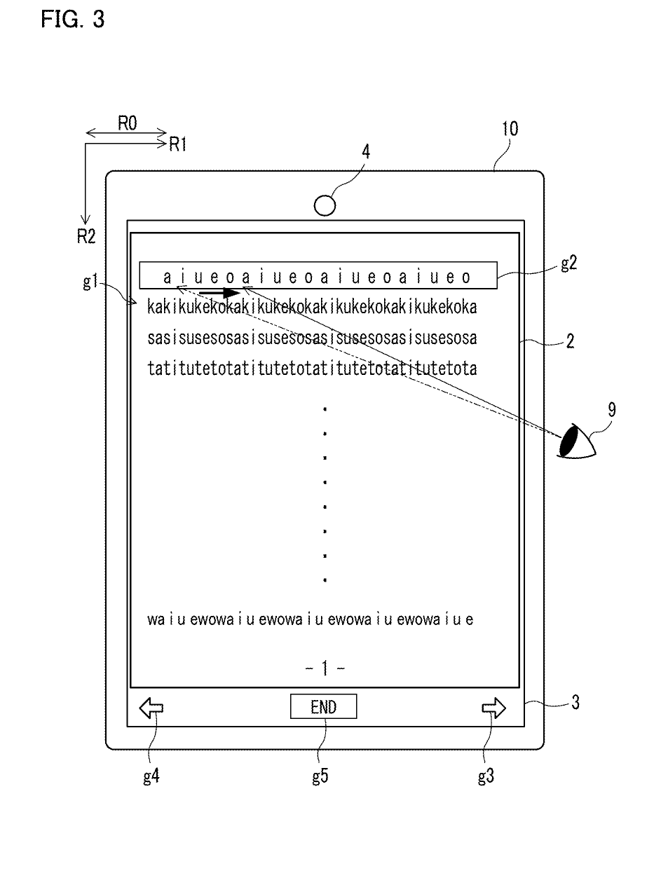

FIG. 3 is a schematic view showing an example of a display state of the page image and a row specifying image described below, in the document browsing device 10. The document browsing device 10 includes a function of displaying, on the display portion 2, a page image g1 including a plurality of rows of character strings in the document of the document data D1. Further, the document browsing device 10 also includes a function of displaying, on the display portion 2, a row specifying image g2 which specifies one row in the page image g1.

In the example shown in FIG. 3, the row specifying image g2 is a frame image which encloses a target row that is one of the rows in the page image g1. It is also conceivable that the row specifying image g2 is a background image in which a background of the target row in the page image g1 is displayed with a color or a pattern different from that of backgrounds of other rows.

Further, it is also conceivable that the row specifying image g2 is a back ground image in which backgrounds of rows from the first row in the page image g1 to a row that is one row before the target row are displayed with a color or a pattern different from that of the backgrounds of the remaining rows including the target row.

Furthermore, it is also conceivable that the row specifying image g2 is an instruction image which is an image of an arrow or an image of a finger which indicates the target row in the page image g1.

In the following description, a direction in which the viewer reads character strings along a row direction R0 of the character strings in the page image g1 is referred to as an intra-row advancing direction R1. In the example shown in FIG. 3, the row direction R0 is a horizontal direction of the rectangular display portion 2, i.e., a width direction of the display portion 2, and the intra-row advancing direction R1 is a direction from a left side to a right side along the width direction of the display portion 2.

Further, a direction in which the viewer continues successively reading the character strings in the page image g1 from a given row to a next row is referred to as an inter-row advancing direction R2. The inter-row advancing direction R2 is a direction orthogonal to the row direction R0. In the example shown in FIG. 3, the inter-row advancing direction R2 is a vertical direction of the rectangular display portion 2, i.e., a direction from an upper side to a lower side along a height direction of the display portion 2.

The MPU 1 of the document browsing device 10 obtains direction specifying information including information of the intra-row advancing direction R1 and the inter-advancing direction R2, and causes the display portion 2 to display the page image g1 according to a format based on the direction specifying information.

For example, it is conceivable that the direction specifying information is included in a part of the document data D1. Further, it is conceivable that the document browsing device 10 includes a function of setting the direction specifying information and recording it in the first storage portion 4 according to an operation performed on the operation portion 3.

In the present embodiment, the camera 5 captures an image including eyes 9 of the viewer. For example, it is conceivable that the camera 5 is a visible light camera. Further, it is conceivable that the camera 5 is a CCD camera.

In the present embodiment, the image processing portion 6 executes image processing of specifying a gaze direction of the viewer by detecting a motion of the eyes 9 of the viewer from at least an image of the camera 5. The image processing portion 6 executes, according to need, inputting of the image of the camera 5, and calculation of the gazing direction based on the input image. Further, the image processing portion 6 determines, according to need, whether or not a predetermined condition relating to a change in the gazing direction is satisfied, and outputs a determination result to the MPU 1.

For example, the image processing portion 6 derives positions of corners and positions of irises of the eyes 9 of the viewer by performing the image processing on the image of the camera 5. Further, the image processing portion 6 calculates a change direction and a change amount of the positions of the irises which are based on the derived positions of the corners of the eyes, as a change direction and a change amount of the gazing direction.

In the present embodiment, the camera 5, the image processing portion 6 and the second storage portion 7 configure a gaze detecting portion 50 which detects a change in the gazing direction of the viewer who looks at the display portion 2.

As described below, the document browsing device 10 has the browsing portion guiding function. The browsing portion guiding function is a function of successively changing the display position of the row specifying image g2 in the page image g1 in response to a change in the gazing direction of the viewer. Thus, the document browsing device 10 appropriately guides the gaze of the viewer to the specific target row which is a row the viewer wants to read.

[Browsing Portion Guiding Function of Document Browsing Device 10]

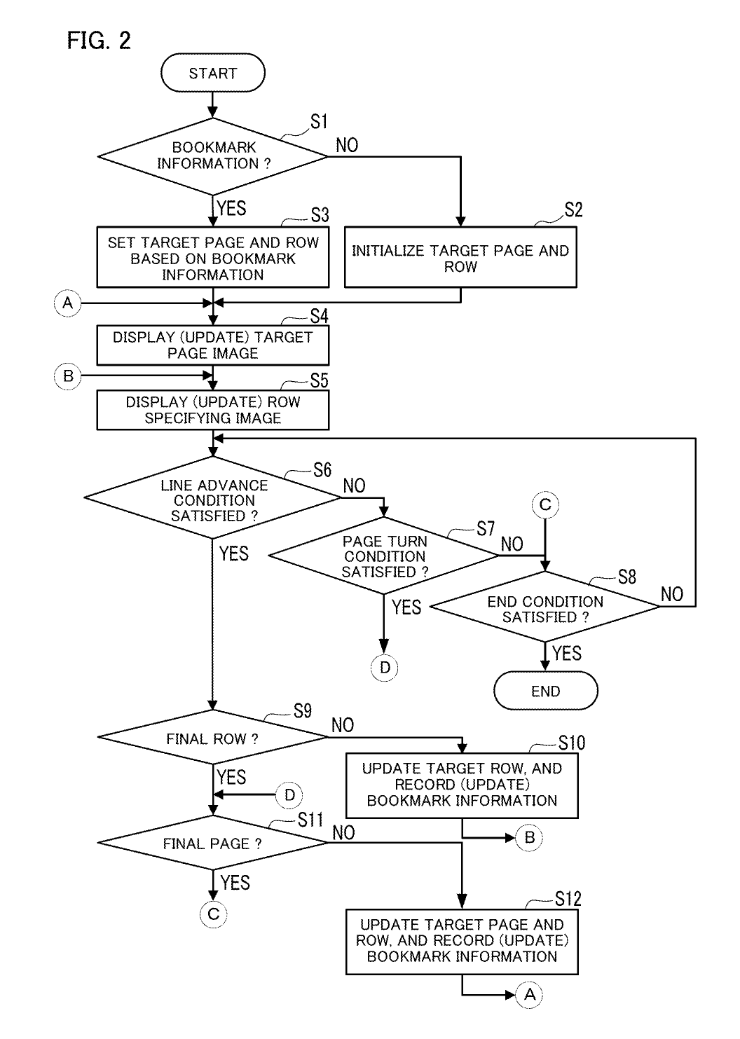

Next, the browsing portion guiding function of the document browsing device 10 will be described with reference to FIGS. 2 to 6. FIG. 2 is a flowchart showing an example of a process of browsing portion guiding control executed by the MPU 1 and the image processing portion 6 of the document browsing device 10. FIGS. 3 to 6 are schematic views showing first to fourth display states of the page image g1 and the row specifying image g2 in the document browsing device 10.

The MPU 1 starts the processing shown in FIG. 2 when detecting occurrence of a predetermined browsing start event. For example, the browsing start event means that a predetermined browsing starting operation is performed on the operation portion 3.

Further, from a point of time at which occurrence of the browsing start event has been detected, the gaze detecting portion 50 detects, according to need, a change in the gazing direction of the viewer, and outputs a detection result to the MPU 1. For example, the gaze detecting portion 50 detects a change in the gazing direction of the viewer at a predetermined cycle.

The browsing starting operation includes an operation of specifying the document data D1 recorded in the first storage portion 4 in advance, and an operation of starting browsing the specified document data D1. Hereinafter, the document data D1 specified by the browsing starting operation is referred to as specified document data.

In the following description, S1, S2, . . . represent identification symbols of a processing order. In addition, the processing of the MPU 1 described below is realized when the MPU 1 executes a computer program stored in the first storage portion 4.

<Step S1>

The MPU 1 determines whether or not bookmark information D2 associated with the specified document data is recorded in the first storage portion 4, upon detecting occurrence of the browsing start event. The bookmark information D2 is information recorded in the first storage portion 4 by the MPU 1 in step S11 and S12 described below.

The bookmark information D2 is information associated with the specified document data and is recorded in the first storage portion 4. The bookmark information D2 includes page information which specifies one target page of a plurality of pages included in the document of the specified document data, and row information which specifies the one target row included in a display target page. The target page is a display target page.

<Step S2>

When the bookmark information D2 associated with the specified document data is not recorded in the first storage portion 4, the MPU 1 sets the target page and the target row to initial values. The initial value of the target page is a head page in the document of the specified document data. The initial value of the target row is a head row in the head page.

<Step S3>

When the bookmark information D2 associated with the specified document data is recorded in the first storage portion 4, the MPU 1 sets the target page and the target row corresponding to the page information and the row information included in the bookmark information D2.

Steps S1 to S3 are realized when the MPU 1 executes a history information obtaining program Pr1 stored in the first storage portion 4. The history information obtaining program Pr1 is a program which causes the MPU 1 to execute a step of obtaining the page information and the row information from the first storage portion 4. The first storage portion 4 in which the bookmark information D2 is recorded is an example of a non-transitory computer-readable storage medium in which history information including the page information and the row information can be recorded.

<Steps S4 and S5>

After step S2 or step S3, the MPU 1 causes the display portion 2 to display the page image g1 corresponding to the target page in the document of the specified document data (S4). In this regard, the MPU 1 causes the display portion 2 to display the row specifying image g2 which specifies the target row in the page image g1, as a part of the page image g1 (S5).

FIG. 3 shows a state where the page image g1 of the first page in the document of the specified document data and the row specifying image g2 which specifies a head row are displayed on the display portion 2.

Step S4 is realized when the MPU 1 executes a first display control program Pr2 stored in the first storage portion 4. The first display control program Pr2 is a program which causes the MPU 1 to execute a step of causing the display portion 2 to display the page image g1 including a plurality of rows of character strings in the document. The MPU 1 which executes the first display control program Pr2 is an example of a first display control portion which causes the display portion 2 to display the page image g1.

Further, step S5 is realized when the MPU 1 executes a second display control program Pr3 stored in the first storage portion 4. The second display control program Pr3 is a program which causes the MPU 1 to execute a step of causing the display portion 2 to display the row specifying image g2 which specifies one row in the page image g1. The MPU 1 which executes the second display control program Pr3 is an example of a second display control portion which causes the display portion 2 to display the row specifying image g2.

In the case where the processing of the MPU 1 shifts to steps S4 and S5 after steps S1 and S3, the MPU 1, in step S4, causes the display portion 2 to display the page image g1 in response to occurrence of the browsing start event other than a page turn event described below. In this regard, the MPU 1 causes the display portion 2 to display the page image g1 corresponding to the page information of the bookmark information D2 recorded in the first storage portion 4.

Similarly, in the case where the processing of the MPU 1 shifts to steps S4 and S5 after steps S1 and S3, the MPU 1, in step S5, causes the display portion 2 to display the row specifying image g2. The row specifying image g2 is an image which specifies a row corresponding to the row information of the bookmark information D2 recorded in the first storage portion 4.

<Steps S6 to S8>

Further, in a state where the page image g1 corresponding to the target page and the row specifying image g2 corresponding to the target row are displayed on the display portion 2, the MPU 1 determines whether or not each of three conditions described below is satisfied while referring to a detection result of the gaze detecting portion 50. The MPU 1 repeats the determination until any one of these three conditions is satisfied.

The first condition determined in step S6 is a line advance condition indicating that the gazing direction detected by the gaze detecting portion 50 has shown a predetermined change along the row direction R0 of the character strings in the page image g1. A direction which goes along the row direction R0 in the line advance condition roughly includes a range from a direction parallel to the row direction R0 to a direction which goes along a line connecting a last character in a row and a head character in a row next to the row.

For example, it is conceivable that the line advance condition includes a condition that at least the gazing direction has shown a change exceeding a predetermined change amount in a direction opposite to the intra-row advancing direction R1 along the row direction R0. An example of the line advance direction is that the gazing direction has shown a change exceeding a set change amount corresponding to about half to ⅔ of a length of one row in the direction opposite to the intra-row advancing direction R1.

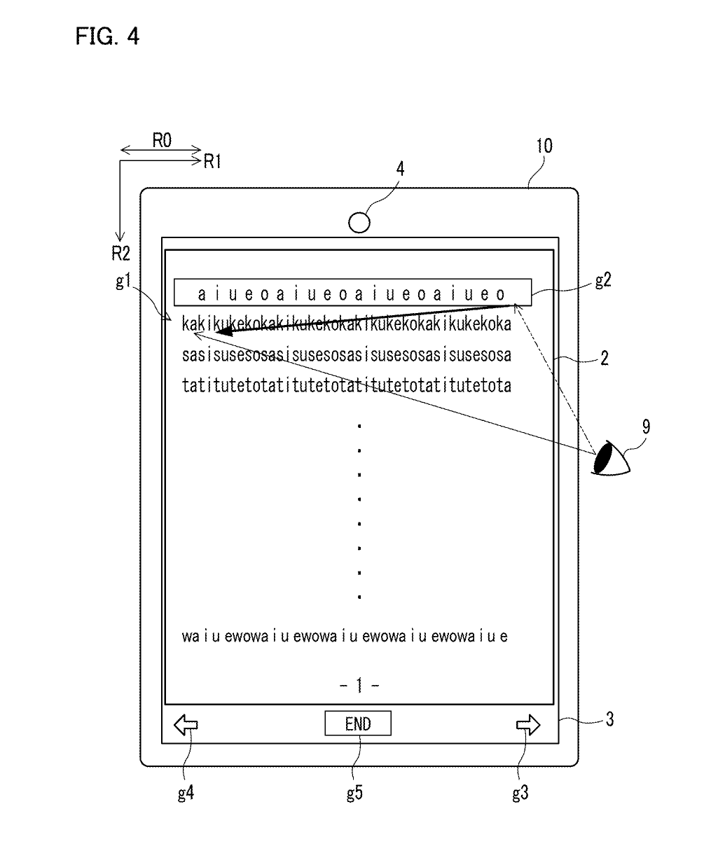

FIG. 4 shows a state where the gazing direction has shown a change from a direction facing the last character of the target row to a direction facing the head character of the row next to the target row, and the line advance condition has been satisfied.

That is, in step S6, the MPU 1 refers to the detection result of the gaze detecting portion 50, and determines whether or not the line advance condition has been satisfied. The line advance condition is a condition indicating that the gazing direction has shown a predetermined change along the row direction R0 in the page image g1.

Step S6 is realized when MPU 1 executes a first condition determining program Pr4 stored in the first storage portion 4. The first condition determining program Pr4 is a program which causes the MPU 1 to execute a step of determining whether or not the line advance condition has been satisfied. The MPU 1 which executes the first condition determining program Pr4 is an example of a first condition determining portion.

The second condition determined in step S7 is a page turn condition indicating that a predetermined page turn event has occurred. For example, the page turn event indicates that a page turning operation such as a predetermined page turning operation or page turning back operation has been performed on the operation portion 3.

In the examples shown in FIGS. 3 to 6, the display portion 2 displays a page turn icon g3 and a page turn-back icon g4 together with the page image g1 and the row specifying image g2. In this case, when a portion of the page turn icon g3 in the operation portion 3 is operated, the MPU 1 detects that the page turning operation has been performed.

Further, it is also conceivable that the page turn condition of the page turn event is a condition indicating that the gazing direction has shown a predetermined change along a direction which intersects the row direction R0 in the page image g1.

For example, it is conceivable that a change in the gazing direction exceeding a predetermined change amount in a direction from a final row side in the page image g1 to a head row side is the page turn condition. The page turn condition is, for example, a condition indicating that the gazing direction has shown a change exceeding a set change amount corresponding to about half to ⅔ of a dimension of the page image g1 in the inter-row advancing direction R2, from a direction facing the vicinity of a last character in a final row in the page image g1 to a direction facing the vicinity of a head character of a head row, or a condition including this change as part of the condition.

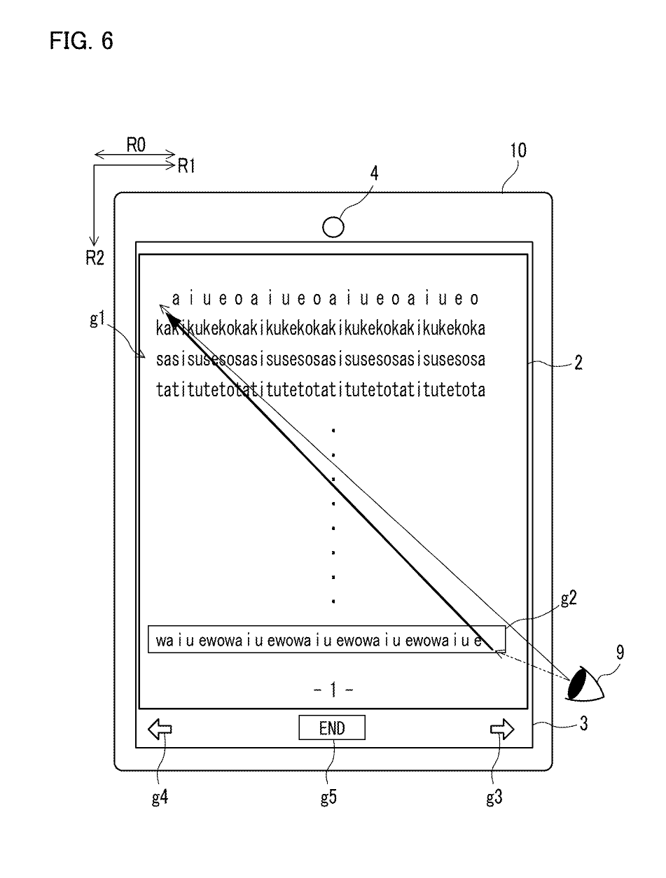

FIG. 6 shows the state where the gazing direction has shown a change from a direction facing a final character of a final row in the page image g1 to a direction facing a head character of a head row, and the page turn condition has been satisfied. In addition, in the example of FIG. 6, the positions of the final character of the final row and the head character of the head row in the page image g1 correspond to a lower right end portion and an upper left portion of the page image g1.

In step S7, the MPU 1 which executes a second condition determining program Pr5 stored in the first storage portion 4 is an example of a page turn event detecting portion which detects that the page turning operation has caused the page turn event. The second condition determining program Pr5 is a program which causes the MPU 1 to execute a step of detecting occurrence of the page turn event.

Further, in step S7, the image processing portion 6 is also an example of a page turn event detecting portion which detects that the page turn event has occurred by detecting whether or not the gazing direction satisfies the page turn condition.

The third condition determined in step S8 is an end condition to end processing of displaying the page image g1 and the row specifying image g2. For example, the end condition includes that a predetermined ending operation has been performed on the operation portion 3.

In the examples shown in FIGS. 3 to 6, the display portion 2 displays an end icon g5 together with the page image g1 and the row specifying image g2. In this case, when a portion of the end icon g5 on the operation portion 3 is operated, the MPU 1 detects that the ending operation has been performed.

Further, it is also conceivable that the end condition includes that a state where the operation with respect to the operation portion 3 is not detected or a state where the gazing direction cannot be detected continues for a predetermined time.

In step S8, the MPU 1 which executes a third condition determining program Pr6 stored in the first storage portion 4 determines that the end condition has been satisfied, by detecting the ending operation. The third condition determining program Pr6 is a program which causes the MPU 1 to execute a step of determining whether or not the end condition can be satisfied.

Further, in step S8, the image processing portion 6 determines whether or not the end condition can be satisfied, by determining whether or not the gazing direction can be detected.

<Step S9>

In the case where the line advance condition has been satisfied, the MPU 1 determines whether or not the target row at a point of time of the satisfaction is a final row in the page image g1.

<Step S10>

When the target row is not the final row in the page image g1, the MPU 1 updates the target row to the next row. Further, the MPU 1 records the page information and the bookmark information D2 in the first storage portion 4. The page information to be recorded is information corresponding to the latest page image g1 displayed on the display portion 2. Further, the bookmark information D2 to be recorded includes the row information corresponding to the latest row specifying image g2 displayed on the display portion 2.

In step S10, in the case where the bookmark information D2 corresponding to the page image g1 which is being displayed on the display portion 2 has already been recorded in the first storage portion 4, the MPU 1 updates the bookmark information D2 to new information.

Then, the MPU 1 shifts the processing from step S10 to above-described step S5. Thus, in step S5, the MPU 1 updates the display state of the row specifying image g1 on the display portion 2, to a state to specify the updated target row.

When the processing of the MPU 1 shifts to step S5 after steps S6, S9 and S10, i.e., in the case where the line advance condition (first condition) has been satisfied, in step S5, the MPU 1 updates the display state of the row specifying image g2 on the display portion 2, to a state to specify a row next to the row to be specified at a point of time of the satisfaction.

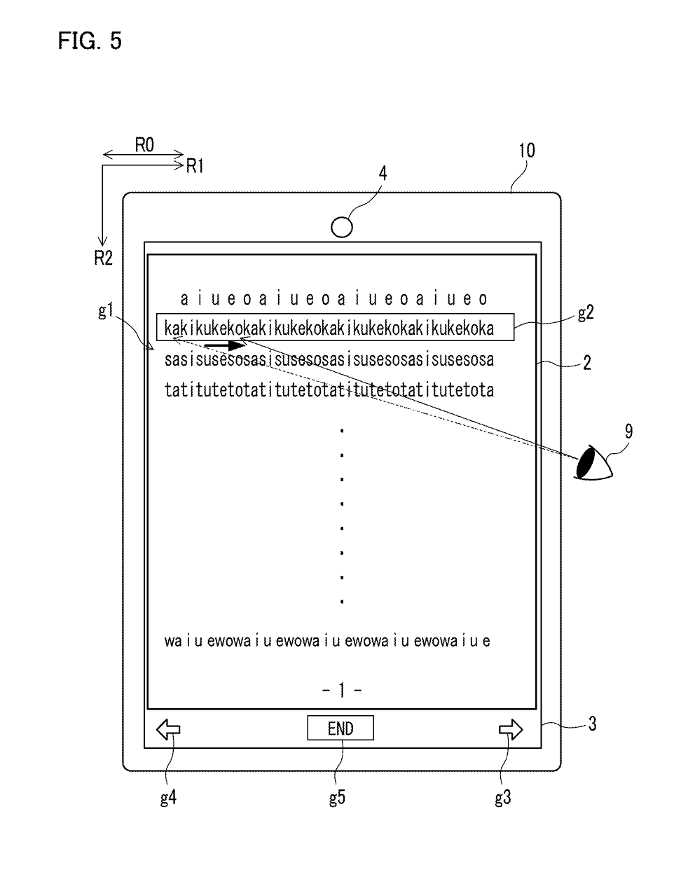

FIG. 5 shows that the line advance condition has been satisfied, and then the row specifying image g2 has changed from the states in FIGS. 3 and 4 to specify the head row in the page image g1, to a state to specify a second row.

In step S10, the latest page image g1 displayed on the display portion 2 is the page image g1 displayed on the display portion 2 at the point of time of step S10. Further, in step S10, the latest row specifying image g2 displayed on the display portion 2 is the row specifying image g2 is the row specifying image g2 displayed on the display portion 2 in step S5 subsequent to step S10.

<Step S11>

In the case where the target row at a point of time when the line advance condition has been satisfied is the final row in the page image g1 or in the case where the page turn condition has been satisfied, the MPU 1 determines whether or not the target page at the point of time of the satisfaction is a final page of the document. In addition, when the page turn event occurs, the page turn condition is satisfied.

In step S11, when the target page at the point of time of the satisfaction is a final page of the document, i.e., the page image g1 of the final image is displayed on the display portion 2, the MPU 1 shifts the processing to above-described step S8. Thus, the MPU 1 continues determining the end condition until the end condition is satisfied.

<Step S12>

In step S11, when it is determined that the target page at the point of time of the satisfaction is not the final page of the document, the MPU 1 updates the target page to a next page. Further, the MPU 1 updates the target row to a head row.

Step S12 is executed when the page turn condition is satisfied in a state where the page image g1 in a page other than the final page is displayed on the display portion 2. Further, step S12 is also executed when the line advance condition is satisfied in a state where the page image g1 in a page other than the final page and the row specifying image which specifies a final row are displayed on the display portion 2.

Further, in step S12, the MPU 1 records the page information and the bookmark information D2 in the first storage portion 4. The page information is information corresponding to the latest page information g1 displayed on the display portion 2. The bookmark information D2 is information including the row information corresponding to the latest row specifying information g2 displayed on the display portion 2. In the case where the bookmark information D2 corresponding to the page image g1 which is being displayed on the display portion 2 has already been recorded in the first storage portion 4, the MPU 1 updates this bookmark information D2 to new information.

The MPU 1 shifts the processing from step S12 to above-described step S4. Thus, in step S4, the MPU 1 updates the display state of the page image g1 on the display portion 2, to a state to display the page image g1 corresponding to the updated target page. Subsequently, in step S5, the MPU 1 updates the display state of the row specifying image g1 on the display portion 2, to a state to specify a head row in the newly displayed page image g1.

The line advance condition being satisfied in the state where the page image g1 of a page other than the final page and the row specifying image g2 which specifies the final row are displayed on the display portion 2 is an example of the page turn event.

In step S12, the latest page image g1 displayed on the display portion 2 is the page image g1 displayed on the display portion 2 in step S4 subsequent to step S12. Similarly, in step S12, the latest row specifying image g2 displayed on the display portion 2 is the row specifying image g2 displayed on the display portion 2 in step S5 next to step S4 subsequent to step S12.

When the processing of the MPU 1 shifts to steps S4 and S5 after steps S7, S11 and S12, in step S4, the MPU 1 causes the display portion 2 to display the page image g1 in response to occurrence of the page turn event. In this regard, the MPU 1 updates the display state of the display portion 2, to a state to display the page image g1 of a page next to the page which is displayed at a point of time when the page turning has occurred.

Similarly, when the processing of the MPU 1 moves to steps S4 and S5 after steps S7, S11 and S12, in step S5, the MPU 1 causes the display portion 2 to display the row specifying image g2 which is used to specify the head row.

Steps S10 and S12 are realized when the MPU 1 executes a history information recording program Pr7 stored in the storage portion 4. The history information recording program Pr7 is a program which causes the MPU 1 to execute a step of recording the page information and the row information in the first storage portion 4. The page information to be recorded is information corresponding to the latest page information g1 to be displayed on the display portion 2. Further, the row information to be recorded is information corresponding to the latest row specifying image g2. The MPU 1 which executes the history information recording program Pr7 is an example of a history information recording portion which records the page information and the row information in the first storage portion 4.

By the way, it is also conceivable that, in step S7, the MPU 1 determines whether or not the page turn condition and, in addition, a page turn-back condition can be satisfied. In the case where the predetermined page turn-back event has occurred, the page turn-back condition is satisfied.

In the case where the page turn-back condition has been satisfied, in step S11, the MPU 1 determines whether or not the target page is a head page. When the target page is not the head page, in step S12, the MPU 1 updates the target page to a previous page, and updates the target row to a head row.

Further, in step S12, the MPU 1 records, in the first storage portion 4, the bookmark information D2 including the page information and the row information corresponding to the updated target page and target row. In the case where the bookmark information D2 has already existed, the MPU 1 updates the bookmark information.

When, for example, a portion of the page turn-back icon g4 on the operation portion 3 is operated, the MPU 1 detects occurrence of the page turn-back event.

Further, it is also conceivable that, when the gaze detecting portion 50 detects a predetermined change in the gaze direction for turning back a page, the MPU 1 detects the occurrence of the page turn-back event. When, for example, the gaze detecting portion 50 detects a change corresponding to a turn of the gazing direction, the MPU 1 detects the occurrence of the page turn-back event.

As described above, the document browsing device 10 includes the browsing portion guiding function of appropriately guiding the gaze of the viewer to a portion of display document that the viewer wants to read.

That is, the document browsing device 10 causes the display portion 2 to display the row specifying image g2 which specifies each row from a head row in the page image g1 in order. Hence, the viewer can intuitively grasp a row that the viewer is about to read.

Further, when the viewer moves his/her gaze to a head side of a row after finishing reading a row specified based on the row specifying image g2, the document browsing device 10 updates the display state of the row specifying image g2 to a state to specify a next row. Updating the display of the row specifying image g2 in this way appropriately leads the gaze of the viewer to a head of the next row.

Hence, by adopting the document browsing device 10, it is possible to avoid inconvenience that the viewer moves his/her gaze to a head of an unintended row. This document browsing device 10 is highly convenient.

Further, the document browsing device 10 changes the display position of the row specifying image g2 according to the detection result of the gazing direction of the viewer. Consequently, even under a situation that the viewer uses the document browsing device 10 only by one hand, the document browsing device 10 can provide the browsing portion guiding function.

That is, by adopting a method of controlling the document browsing device 10, it is possible to appropriately guide the gaze of the viewer to a portion of display document that the viewer wants to read. Further, even under a situation that the viewer uses the document browsing device 10 only by one hand, the document browsing device 10 can provide the browsing portion guiding function.

Furthermore, when detecting occurrence of the page turn event, the document browsing device 10 updates the display state of the display portion 2 to a state to display the page image g1 of a next page, and causes the display portion 2 to display the row specifying image g2 which is used to specify a head row.

Consequently, even when the viewer wants to continues reading the document from a given page to a next page, the document browsing device 10 can appropriately guide the gaze of the viewer to a portion that the viewer wants to read.

Further, the document browsing device 10 records the bookmark information D2 corresponding to the latest page image g1 and row specifying image g2. Furthermore, when a predetermined event such as the browsing start event occurs, the document browsing device 10 causes the display portion 2 to display the page image g1 and the row specifying image g2 corresponding to a page and a row specified by the recorded bookmark information D2.

Hence, the document browsing device 10 not only stores page information which is being browsed similar to a general bookmark function but also stores information of a row in a page which is being browsed. Consequently, when the viewer resumes browsing the document after stopping browsing the document, the document browsing device 10 can appropriately guide the gaze of the viewer to the browsing page and row at which the viewer stops browsing. In this case, it is possible to save the viewer the trouble of searching for a browsing row at which the viewer stops browsing, depending on the memory of the viewer.

Further, when the gazing direction has shown a change exceeding a predetermined change amount in a direction opposite to a direction in which the viewer reads the character strings along the row direction R0, the document browsing device 10 determines that a line break condition (the first condition) has been satisfied.

The above change in the gazing direction is a natural change in the gazing direction in a process in which the viewer continues reading the character strings from a given row to a next row. Consequently, the viewer can use the document browsing device 10 without feeling strangeness.

Further, in the case where the gazing direction has shown a change exceeding a predetermined change amount in a direction from a final row side to a head row side in the page image, the document browsing device 10 determines that a page break condition (second condition) has been satisfied. A direction from the final row side to a head row side in the page image is an example of a direction which intersects the row direction R0.

The above change in the gazing direction is also a natural change in the gazing direction in a process in which the viewer continues reading the character strings from a given page to a next page. Consequently, the viewer can use the document browsing device 10 without feeling strangeness.

Further, the gaze detecting portion 50 including the camera 5 and the image processing portion 6 can detect the gazing direction with a relatively simple configuration.

### APPLICATION EXAMPLE

It is conceivable that, in the document browsing device 10, the gaze detecting portion 50 includes an infrared camera which captures an image of a near infrared ray and an infrared light source which outputs a near infrared ray, instead of the visible light camera 5.

The infrared camera captures an image including the eyes 9 of the viewer. The infrared light source is a light source which irradiates a region including the eyes 9 of the viewer with an infrared ray. For example, it is conceivable that the infrared camera is a CC camera. Further, it is conceivable that the infrared light source is a LED light source.

In the application example, the image processing portion 6 executes image processing according to a known corneal reflex method of specifying a gazing direction of a viewer from an image captured by the infrared camera. In this case, the image processing portion 6 detects a corneal reflex position which is a position at which light of the infrared light source from the image captured by the infrared camera is reflected by corneas of the eyes. Further, the image processing portion 6 also detects center positions of pupils of the viewer. Further, the image processing portion 6 calculates a gazing direction vector of the infrared camera based on a relationship between the corneal reflex position which is not influenced by the gazing direction and the center positions of the pupils which change according to the gazing direction.

When image processing according to the corneal reflex method is adopted, it is possible to more precisely detect the change in the gazing direction.

It is also conceivable that, in above steps S6 to S8, the MPU 1 determines a condition obtained by combining each of the conditions described in the embodiment with another condition, as the line advance condition, the page turn condition and the end condition. In this case, it is conceivable that OR or AND of each of the conditions described in the embodiment and the other condition is each of the line advance condition, the page turn condition and the end condition.

In addition, the document browsing device and the method of controlling the document browsing device according to the present disclosure can also be configured by freely combining the above-described embodiment and the application example, optionally deforming the embodiment and the application example or omitting part of the embodiment and the application example within the scope of the invention recited in each claim.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A document browsing device comprising:
a first display control portion configured to cause a display portion to display a page image including a plurality of rows of character strings in a document;
a second display control portion configured to cause the display portion to display a row specifying image which specifies one row in the page image;
a gaze detecting portion configured to detect a change in a gazing direction of a viewer who looks at the display portion; and
a first condition determining portion configured to refer to a detection result of the gaze detecting portion and determine whether or not a first condition has been satisfied, wherein
the first condition is a condition which indicates that the gazing direction has shown a predetermined change along a row direction of the character strings in the page image, and
in a case where the first condition has been satisfied, the second display control portion updates a display state of the row specifying image on the display portion, to a state to specify a row next to a row to be specified at a point of time of the satisfaction.

2. The document browsing device according to claim 1, further comprising a page turn event detecting portion configured to detect that a predetermined page turn event has occurred, wherein
in the case where the occurrence of the page turn event has been detected, the first display control portion updates the display state of the page image on the display portion, to a state to display the page image of a page next to a page which is being displayed at a point of time of the detection, and the second display control portion causes the display portion to display the row specifying image which specifies a head row in the updated page image.

3. The document browsing device according to claim 2, further comprising a history information recording portion configured to record page information and row information in a non-transitory computer-readable storage medium, wherein
the page information is information corresponding to the latest page information displayed on the display portion,
the row information is information corresponding to the latest row specifying image displayed on the display portion, and
when causing the display portion to display the page image in response to occurrence of an event other than the page turn event, the first display control portion causes the display portion to display the page image corresponding to the page information recorded in the non-transitory computer-readable storage medium, and the second display control portion causes the display portion to display the row specifying image which specifies a row corresponding to the row information recorded in the non-transitory computer-readable storage medium.

4. The document browsing device according to claim 2, wherein
the page turn event detecting portion refers to a detection result of the gaze detecting portion and detects that a second condition has been satisfied, as occurrence of the page turn event, and
the second condition is a condition indicating that the gazing direction has shown a predetermined change along a direction which intersects a row direction of the character strings in the page image.

5. The document browsing device according to claim 4, wherein the second condition includes that the gazing direction has shown a change exceeding a predetermined change amount in a direction from a final row side to a head row side in the page image.

6. The document browsing device according to claim 1, wherein the first condition includes that the gazing direction has shown a change exceeding a predetermined change amount in a direction opposite to a direction to read the character strings along a row direction of the character strings.

7. The document browsing device according to claim 1, wherein the gaze detecting portion includes:
a camera configured to capture an image of an eye of the viewer; and
an image processing portion configured to specify a change in the gazing direction, by detecting a motion of the eye of the viewer from the image captured by the camera.

8. A method of controlling a document browsing device which comprises a display portion and a gaze detecting portion configured to detect a change in a gazing direction of a viewer who looks at the display portion, the method comprising:
causing the display portion to display a page image including a plurality of rows of character strings in document;
causing the display portion to display a row specifying image which specifies one row in the page image;
referring to a detection result of the gaze detecting portion and determining whether or not a predetermined condition has been satisfied; and
in the case where the predetermined condition has been satisfied, updating a display state of the row specifying image on the display portion to a state to specify a row next to a row to be specified at a point of time of the satisfaction, wherein
the predetermined condition is a condition which indicates that the gazing direction has shown a predetermined change along a row direction of the character strings in the page image.
